(19) United States
(12) Patent Application Publication
(10) Pub. No.: US 2010/0075102 A1
(43) Pub. Date: Mar. 25, 2010

(54) REMOVABLE ANTI-GLARE FILMS FOR FLAT PANEL DISPLAYS

(76) Inventors: Jeffrey A. Lev, Tomball, TX (US); Paul J. Doczy, Cypress, TX (US); Mark S. Tracy, Tomball, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/236,635

(22) Filed: Sep. 24, 2008

(51) Int. Cl. B32B 3/06

(52) U.S. Cl. 428/99

(57) ABSTRACT

A removable and reusable anti-glare film for a flat panel display. In one embodiment, the film includes a body portion including an outer surface having a matte finish that diffuses ambient light, and attachment features associated with the body portion that are adapted to attach the anti-glare film to the flat panel display, wherein the body portion overlies a display screen of the flat panel display when the anti-glare film is attached to the flat panel display.

### BACKGROUND

Traditionally, the displays of notebook computers comprise a matte, anti-glare finish that disperses ambient light to reduce the intensity of light that; can reflect off of the display and into a user's eyes. More recently, however, glossy displays have been gaining in popularity with the purchasing public. An advantage of glossy displays, which are also sometimes referred to as “anti-reflective” displays, is that glossy displays do not diffuse the light emitted by the display, thereby reducing blurring of displayed images. The result is brighter, higher contrast images.

Although glossy displays may be considered superior under certain conditions, they perform less well in other conditions. For example, although glossy displays work well in most office settings, they can create harsh reflections that can obscure the view of the displayed images in outdoor settings or settings in which one or more bright light sources are located in a position in which the light they emit can reflect off of the display toward the user.

Unfortunately, notebook computers; are typically only offered with one of the two alternative types of displays. Therefore, a computer cannot be purchased that provides optimal results may not be achievable under all use conditions.

### BRIEF DESCRIPTION OF THE DRAWINGS

The disclosed computing devices can be better understood with reference to the following drawings. The components in the drawings are not necessarily to scale.

FIG. 1 is a perspective view of an embodiment of a computing device and a removable anti-glare film that can be placed over a display screen of the computing device.

FIG. 2 is a front view of an embodiment of the removable anti-glare film shown in FIG. 1.

FIG. 3 is a side view of the removable anti-glare film of FIG. 2.

FIGS. 4A and 4B are a side views of the computing device shown in FIG. 1, illustrating attachment of the removable: anti-glare film of FIGS. 2 and 3 to the computing device.

FIG. 5 is a further perspective view of the computing device shown in FIG. 1 with the removable anti-glare film of FIGS. 2 and 3 shown attached to the display screen of the computing device.

FIG. 6 is a perspective view of an embodiment of an independent flat panel display and a removable anti-glare film that can be placed over a screen of the display.

### DETAILED DESCRIPTION

As described above, anti-glare and glossy displays have attendant advantages and disadvantages. Unfortunately, notebook computer purchasers are typically left with a choice between one type of display or the other, such that the best results cannot be obtained for every use scenario. As described in the following, however, the advantages of both types, display can be exploited while simultaneously avoiding the attendant disadvantages when the computing device comprises a glossy display and a removable anti-glare film. In such a case, the sheen of the display is user-selectable so that the display can be optimized for the ambient conditions in which the computing device is used.

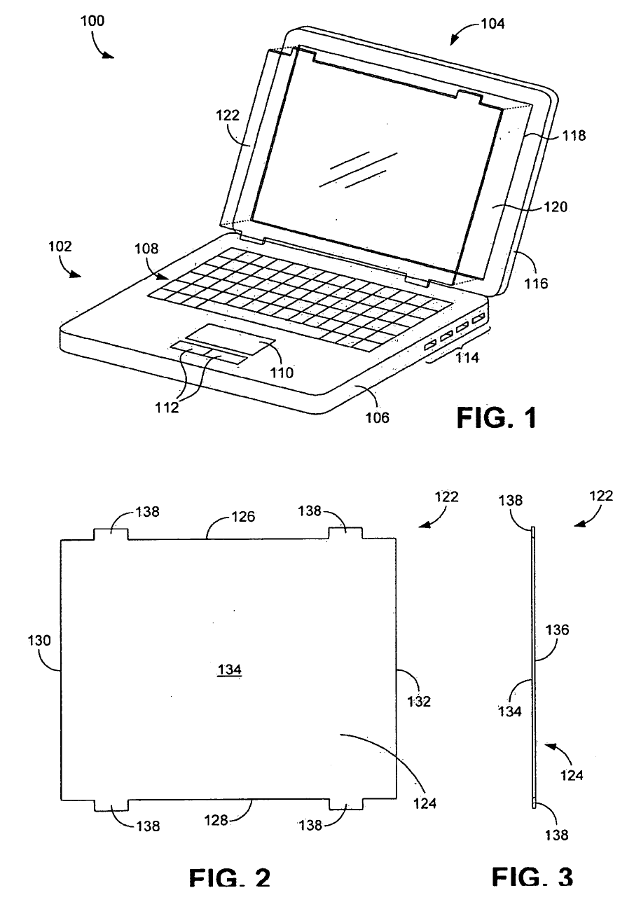

Referring now in more detail to the drawings in which like numerals indicate corresponding parts throughout the views, FIG. 1 illustrates a computing device 100 in the form of a notebook of “laptop” computer. Although, a notebook computer has been explicitly illustrated and identified, it is noted that the notebook computer is cited only as an example. Therefore, the teachings of the present disclosure equally apply to other computing devices such desktop computers, personal digital assistants, mobile telephones, and game consoles. Furthermore, the teachings equally apply to independent flat panel displays and televisions.

As indicated in FIG. 1, the computing device 100 includes a base portion 102 and a display portion 104 that are attached to each other with a hinge mechanism (not shown). The base portion 102 includes an outer housing 106 that surrounds various internal components of the computing device 100, such as a processor, memory, hard drive, and the like. Also included in the base portion 102 are user input devices, including a keyboard 108, a mouse pad 110, and selection buttons 112, as well as various ports or connectors 114 that are accessible through the housing 106.

The display portion 102 includes its own outer housing 116 that defines an opening 118 through which a display screen 120 may be viewed. In some embodiments, the display screen 120 comprises part of a liquid crystal display (LCD) or light-emitting diode (LED) display. The display screen 120 has a glossy outer surface to which no anti-glare coating or finish has been provided. The computing device 100 may therefore be described as comprising a “glossy display.” In some embodiments, the outer surface of the display screen 120 has been chemically treated to reduce ambient light reflection. In such cases, the computing device 100 may also be considered to comprise an “anti-reflective display.” Regardless, because of the absence of a matte finish, the display screen 120 generates very bright, high-contrast images, but may undesirably reflects ambient light.

Further depicted in FIG. 1 is a frameless, removable, reusable anti-glare panel or film 122 that is adapted to be placed directly over the display screen 120. As described in greater detail below, the anti-glare film 122 has a matte finish that disperses ambient light for superior viewing in high-light conditions, such as outdoors, near windows, or in rooms in which bright light sources are located in positions in which their emitted light can reflect off of the display toward the user. FIGS. 2 and 3 describe an example embodiment for the anti-glare film 122.

As indicated in FIGS. 2 and 3, the anti-glare film 122 has generally rectangular body portion 124 that is defined by a first or top edge 126, a second or bottom edge 128, and two opposed lateral edges 130 and 132. In some embodiments, the body portion 124 has dimensions that are similar to or the same as the display screen 120 to which the anti-glare film 122 is adapted to be applied. By way of example, the body portion 124 is composed of a sheet of polymeric material such as an optical grade acrylic or polycarbonate and is approximately 0.5 to 1.0 millimeters (mm) thick such that it is flexible. The body portion 124 includes an outer surface 134 having a matte finish intended to face the user. By way of example, the matte finish can be formed by etching (e.g., acid etching) or sanding to create a relatively rough surface texture that diffuses light. In addition, the body portion 124 includes an inner surface 136 (FIG. 3) intended to face the display screen 120. The inner surface 136 can comprise a glossy surface or a further matte surface. In some embodiments, the body portion 124 further comprises a polarizer an/or a polarizing layer that controls the polarization of light generated by the display screen 120 that passes through the film 122.

Provided along the edges of the body portion 124 are multiple attachment features. In the illustrated embodiment, those attachment features comprise attachment tabs 138 that extend outward from the body portion 124 and, more particularly, from the top and bottom edges 126 and 128 of the body portion. As described below, the attachment tabs 128 are adapted for receipt by attachment slots provided in the outer housing 116 of the display portion 104 of the computing device 100 (FIG. 1). As indicated in FIG. 2, the attachment tabs 138 can comprise rectangular elements that are unitarily formed with the body portion 124. In such embodiments, the attachment tabs 128 can be constructed of the same material as the body portion 124 and can therefore have the same thickness as the body portion. Such a result is achieved when the anti-glare film 122 can is cut from a single piece of sheeting material.

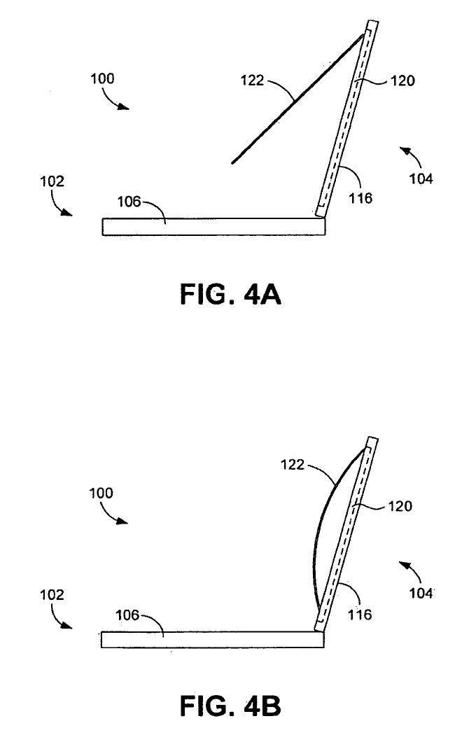

FIGS. 4A and 4B illustrate attachment of the anti-glare film 122 to the display portion 104 of the computing device 100. As indicated in FIG. 4A, the top edge 126 (or the bottom edge 128, if desired) of the anti-glare film 122 is positioned adjacent a corresponding edge of the display screen 120 so that the attachment tabs 138 align with attachment slots of the housing 116. FIG. 5 illustrates an example of such slots. As shown in that figure, the housing 116 includes a front bezel 140 that comprises integral attachment slots 142 that have openings 144 positioned at the junction of the display screen 120 and the bezel. The attachment slots 142 are specifically adapted to receive the attachment tabs 138 and are therefore substantially coplanar with the outer surface of the display screen 120. The attachment slots 142 have dimensions that are slightly larger than those of the attachment tabs 138 and, as is further indicated in FIG. 5, are at least partially hidden within the bezel 140 so as to not be immediately apparent to the observer.

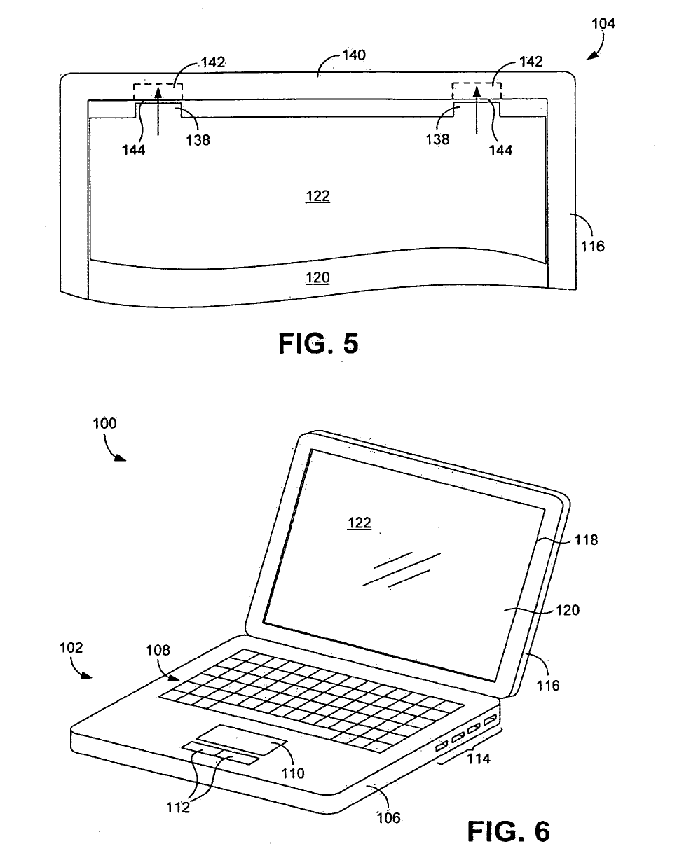

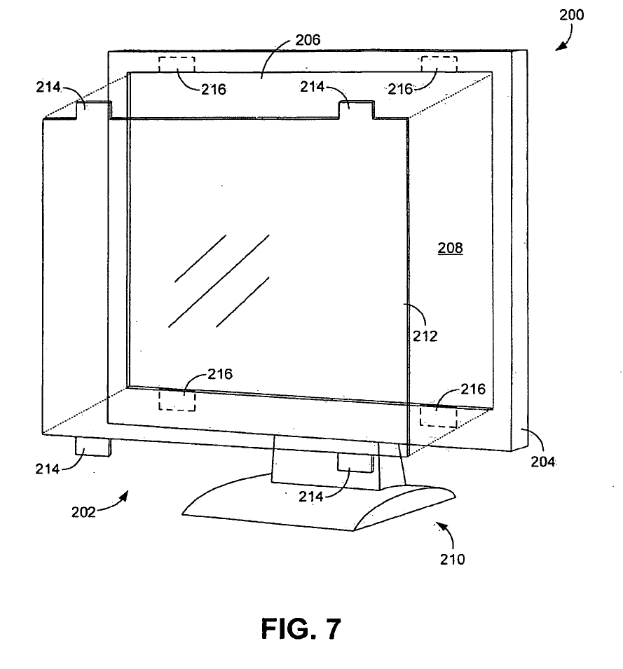

Returning to FIG. 4A, the attachment tabs 138 along the top edge 126 of the anti-glare film 122 can be toed into the corresponding attachment slots of the housing 116 such that the top edge of the anti-glare film is secured to the display portion 104 adjacent a top edge of the display screen 120. Next, with reference to FIG. 4B, the anti-glare film 122 can be bent or flexed to enable the attachment tabs 138 provided along the bottom edge 128 of the body portion 124 to insert into similar attachment slots provided along the bottom edge of the display screen 120. Once each attachment tab 138 has been received within an attachment slot 142, the anti-glare film 122 will rest directly on top of and in contact with the outer surface of the display screen 120, as indicated in FIG. 6. As is apparent from that FIG., the anti-glare film 122 fits on the display screen 120 in a manner in which the film appears to comprise an integral part of the display portion 104, as opposed to an obtrusive add-on item.

FIG. 7 illustrates an independent flat panel display 200 and ah anti-glare panel or film 202 that can be used in similar manner to the film 138 described in the foregoing. As indicated in FIG. 7, the display 200 comprises, an outer housing 204 that surrounds a display screen 206 that has a glossy outer surface 208. The housing 204 is supported above a support surface, such as a table top, by a stand 210. The anti-glare film 202 includes a body portion 212 having the same or similar characteristics as the body of the film 138. Attachment tabs 214 extend from the body portion 212 that are adapted to be received by attachment slots 216, which are integrated with the housing 204.

With the functionality described above, a user can optimize his or her display for the ambient light conditions in which the display is used. Therefore, if the display is used in a relatively low-light environment, such as in ah office or home setting, the user may choose to use the display without the anti-glare film to view the brightest, highest-contrast images possible. If the display is used in a relatively high-light environment, however, the user may choose to attach the anti-glare film to the display to reduce reflected glare. Because the anti-glare film is removable and reusable, the user can remove and reapply the film as often as is needed. Accordingly, the user can take advantage of the strengths of both glossy displays and anti-glare displays and obtain optimal viewing results in various viewing settings using a single display device.

Claimed are:

1. A removable and reusable anti-glare film for a flat panel display, the film comprising:
a body portion including an outer surface having a matte finish that diffuses ambient light; and
attachment features associated with the body portion that are adapted to attach the anti-glare film to the flat panel display;
wherein the body portion overlies a display screen of the flat panel display when the anti-glare film is attached to the flat panel display.

2. The anti-glare film of claim 1, wherein the body portion is rectangular.

3. The anti-glare film of claim 1, wherein the body portion has dimensions that are similar to the dimensions of the display screen.

4. The anti-glare film of claim 1, wherein the body portion is composed of a polymeric material.

5. The anti-glare film of claim 1, wherein the body portion is composed of acrylic or polycarbonate.

6. The anti-glare film of claim 1, wherein the body portion has a thickness of approximately 0.5 to 1.0 millimeters.

7. The anti-glare film of claim 1, wherein the attachment features comprise attachment tabs that extend out from edges of the body portion, the attachment features being adapted to be received by attachment slots provided in a bezel of the flat panel display.

8. The anti-glare film of claim 7, wherein the attachment tabs extend out from top and bottom edges of the body portion.

9. The anti-glare film of claim 7, wherein the attachment tabs are unitarily formed with the body portion so as to be constructed of the same material of the body portion and so as to have the same thickness of the body portion.

10. The anti-glare film of claim 7, wherein the anti-glare film is formed from a single sheet of material.

11. A removable and reusable anti-glare film for a flat panel display, the film comprising:
a rectangular body portion including a plurality of edges having dimensions that are similar to the dimensions of the edges of a display screen of the flat panel display, the body portion including an outer surface having a matte finish that diffuses ambient light; and
attachment tabs that are unitarily formed with the body portion and that extend outward from edges of the body portion, the attachment tabs being adapted slide into attachment slots provided in a front bezel of the flat panel display that are substantially coplanar with the display screen;
wherein anti-glare film is formed from a single sheet of polymeric material having a thickness of approximately 0.5 to 1.0 millimeters.

12. Apparatus comprising:
a flat panel display comprising an outer housing that includes a front bezel and a rectangular display screen that is surrounded by the front bezel, the front bezel comprising attachment slots having openings positioned at the junction of the display screen and the front bezel; and
an anti-glare film comprising a rectangular body portion having dimensions similar to the dimensions of the display screen and including an ;outer surface having a matte finish that diffuses ambient light, the anti-glare film further comprising attachment tabs that extend out from edges of the body portion, the attachment tabs being adapted to insert into the attachment slots of the front bezel;
wherein when the attachment tabs of the anti-glare film are inserted into the attachment slots of the flat panel display, the body portion of the anti-glare film overlies the display screen of the flat panel display.

13. The apparatus of claim 12, wherein the body portion is composed of a polymeric material.

14. The apparatus of claim 12, wherein the body portion has a thickness of approximately 0.5 to 1.0 millimeters.

15. The apparatus of claim 12, wherein the attachment tabs extend out from top and bottom edges of the body portion of the anti-glare film.

16. The apparatus of claim 12, wherein the attachment tabs are unitarily formed with the body portion so as to be constructed of the same material of the body portion and so as to have the same thickness, of the body portion.

17. The apparatus of claim 12, wherein the anti-glare film is formed from a single sheet of material.

18. The apparatus of claim 12, wherein the apparatus is associated with a notebook computer.

19. A notebook computer comprising:
a base portion;
a display portion pivotally connected to the base portion, the display portion including an outer housing that supports a display screen that has a glossy outer surface, the outer housing including; attachment slots that are adapted to receive attachment tabs of an anti-glare film; and
an anti-glare film comprising a body portion having dimensions similar to the dimensions of the display screen and including an outer surface having a matte finish that diffuses ambient light, the anti-glare film further comprising attachment tabs that extend out from edges of the body portion, the attachment tabs being adapted to be received by the attachment slots of the display portion outer housing;
wherein when the attachment tabs of the anti-glare film are inserted into the attachment slots of the display portion outer housing, the body portion of the anti-glare film overlies the display screen of the display portion.

20. The notebook computer of claim 19, wherein the anti-glare film is formed from a single sheet of polymeric material having a thickness of approximately 0.5 to 1.0 millimeters.
